(19) United States
(12) Patent Application Publication
(10) Pub. No.: US 2002/0172202 A1
(43) Pub. Date: Nov. 21, 2002

(54) Apparatus and method for operating a timer of communication system

(75) Inventor: Kwang-Il Lee, Woolsan (KR)

Correspondence Address: FLESHNER & KIM, LLP, P.O. Box 221200, Chantilly, VA, 20153-1200, US

(73) Assignee: LG Electronics Inc.

(21) Appl. No.: 10/146,819

(22) Filed: May 17, 2002

(30) Foreign Application Priority Data
May 18, 2001 (KR) 27336/2001

(51) Int. Cl. H04L 12/28

(52) U.S. Cl. 370/389; 370/428

(57) ABSTRACT

A communications management system uses a single timer to control the transmission of ATM cells along a plurality of virtual paths/virtual channels (VPs/VCs). The system includes first and second memories, a time counter that records when a data packet is received from a specific VP/VC, and a control unit that controls transmission of data in the received packet based on whether another packet from the same VP/VC was received within a predetermined time-out period. By using a single timer, the system and an associated method reduce hardware and operating constraints which limit performance of conventional ATM transmission systems. This translates into improved capacity in terms of the numbers of virtual paths and virtual channels the system is able to manage.

### BACKGROUND OF THE INVENTION

1. Field of the Invention

The present invention relates to a communication system, and more particularly to an apparatus and a method for operating a timer of an asynchronous transfer mode (ATM) system.

2. Background of the Related Art

An ATM system is a packet-mode transfer mode system based on an asynchronous time division multiplexing method, where a band is assigned only when information to be transmitted exists. In such an ATM system, the fundamental unit for transmitting information is a cell which has a fixed length of 53 bytes. The ATM cell is 53 bytes. Five bytes out of the 53 bytes are used for a header field and the remaining 48 bytes are used for a payload field for transmitting information. The header field includes: a virtual path identifier (VPI) and a virtual channel identifier (VCI) for identifying a connection to which the ATM cell belongs; cell loss priority (CLP) information for indicating whether a cell is allowed to be discarded or not during congestion; and header error check (HEC) information to be used for detecting and controlling errors in the header.

The structure of a service protocol layer of an ATM system is shown in FIG. 1. As shown, the service protocol layer of the ATM system includes an ATM adaptation layer (AAL), an ATM layer, and an ATM physical layer. The AAL segments and reassembles the ATM cell. The ATM layer generates and removes the header of the ATM cell and multiplexes and demultiplexes the ATM cell. The ATM physical layer controls the speed of the ATM cell, generates and verifies an HEC header sequence, and synchronizes a cell. The AAL will now be described in detail.

When various user application data items are received from an upper layer, the AAL controls the received data to have a fixed length of 48 bytes and assembles and segments the received data. Unlike the ATM layer, the AAL is not dependent on the application of real data but the application of the upper layer.

The AAL also provides various service classes according to characters of the data received from the upper layer. The ATM system can, for example, transfer a service having a constant bit rate (CBR) such as an audio service and a service having a variable bit rate (VBR) such as data service.

An AAL type 1, used for a broad band integrated services digital network (B-ISDN) using the CBR, is a design for an application of transmitting a rate equal to the transferred bit rate to a receiving side, while guaranteeing the rate equal to the transferred bit rate and a design for an excellent quality of video or audio data service.

An AAL2, which transfers video/audio data not in a fixed rate but in a variable rate, is a design for providing functions almost identical to the functions of the AAL1.

AAL3 and 4 are protocols for transferring a connection-oriented data packet and a non-connection-oriented data packet. A connection method for these methods is formed of a point-to-point or a point-to-multipoint.

An AAL5 is a protocol that can be applied to connection-oriented data communication and signaling and is a design for a confirmation type data communication service, where an error or a flow must be controlled by re-transmission. The present invention can be applied to at least AAL2 and AAL5 among the various types of the AAL. Examples applied to the AAL2 service will now be described.

The AAL2 is generally realized as a software program due to its complexity. When the AAL2 is realized as hardware in order to increase speed, it is significantly difficult to support multiple virtual paths/virtual channels (VP/VC). In particular, because the AAL2 supports real time data, a timer is used for each VP/VC in order to prevent the delay of a data transfer.

FIG. 2 shows an example of the structure of a timer operating apparatus in a conventional AAL2 protocol service logic. The timer operating apparatus includes an AAL2 service logic 10 for generating the payload of an AAL2 ATM cell using AAL2 data received from an upper layer, a data memory 20 for temporarily storing the AAL2 data by each VP/VC, and a plurality of VP/VC timers 30A through 30N which are in one-to-one correspondence with the VP/VCs for checking lapses of time for storing AAL2 data for respective ones of the VP/VCs. Each of the VP/VC timers 30A through 30N is formed of a binary counter having a uniform size.

The operation of the timer operating apparatus in the conventional AAL2 protocol service logic having the above structure will now be described as follows.

A case, where the AAL2 data is received from the upper layer of the AAL and is transferred to the ATM layer that is a lower layer, will be described. Description of a case, where the AAL2 data is received from the ATM layer and is transferred to the upper layer, will be omitted.

An AAL2 common part sublayer (CPS) packet input for a service supporting the VBR such as some isochronous video or audio traffic is generated as an AAL2 CPS protocol data unit (PDU) by the AAL2 service logic 10 and is transmitted to the ATM layer through an ATM link. The AAL2 service logic 10 includes a CPS layer for dividing the AAL2 CPS packet into the AAL2 CPS PDUs of 48 bytes and assembling the AAL2 CPS packet to the AAL2 CPS PDU of 48 bytes. The size of the AAL2 CPS packet is variable. The maximum length of the AAL2 CPS packet is 45 through 64 bytes.

When the AAL2 service logic 10 generates the AAL2 CPS PDU (the payload of the ATM cell) of 48 bytes, in the case where the size of the AAL2 CPS packet does not fill the payload of the ATM cell, the AAL2 service logic 10 waits for a next AAL2 CPS packet and multiplexes the next AAL2 CPS packet with the previous AAL2 CPS packet when the next AAL2 CPS arrives, to thus create the payload of the ATM cell, in order to effectively use the ATM link.

At this time, because the AAL2 protocol supports a real time service, time spent on waiting for the next AAL2 CPS packet must be restricted. For example, the payload of the ATM cell must be generated and transmitted to the ATM layer within a restricted time (for example, 20 ms). Therefore, when the AAL2 CPS packet does not arrive within 20 ms after one AAL2 CPS packet arrives, the AAL2 service logic 10 generates the AAL2 CPS PDU only by the current AAL2 CPS packet without waiting for the next AAL2 CPS packet.

The AAL2 service logic 10 checks whether the restricted time for generating the AAL2 CPS PDU of each VP/VC has lapsed using the timer that one-to-one corresponds to the VP/VC. When the restricted time has passed, the AAL2 service logic 10 generates the AAL2 CPS PDU only based on the current AAL2 CPS (i.e., without waiting for the next AAL2 CPS) and transmits the generated AAL2 CPS PDU to the ATM layer through the ATM link. The above processes will now be described in greater detail.

When the AAL2 CPS packet of VP/VC #1 is received from the upper layer through the user interface, the AAL2 CPS packet of the VP/VC #1 is temporarily stored in the data memory 20 and the VP/VC #1 timer 30A starts counting at the same time, by the control of the AAL2 service logic 10. When the AAL2 CPS packet of VP/VC #2 is received from the upper layer, the AAL2 CPS packet of the VP/VC #2 is temporarily stored in the data memory 20 and the VP/VC #2 timer 30B starts counting at the same time, by the control of the AAL2 service logic 10.

When the AAL2 service logic 10 receives the AAL2 CPS packet of the corresponding VP/VC, the AAL2 service logic 10 temporarily stores the AAL2 CPS packet of the corresponding VP/VC in the corresponding region of the data memory 20 and drives the corresponding VP/VC timer, to thus check time, for which the AAL2 CPS packet of the corresponding VP/VC is stored.

When the VP/VC #1 timer 30A times out, the AAL2 service logic 10 does not wait for the AAL2 CPS packet of the next VP/VC #1. Instead, logic 10 generates the AAL2 CPS PDU by using the AAL2 CPS packet of the VP/VC #1, which is stored in the data memory 20, and by filling the remaining bits with a specific value, for example, 0, and transfers the generated AAL2 CPS PDU to the ATM layer through the ATM link.

In the timer operating apparatus of the conventional AAL2 service logic, the number of timers that can be realized in a hardware logic device is restricted because the timer operating apparatus includes a plurality of timers each of which one-to-one corresponds to each VP/VC. Because the number of timers that correspond to each VP/VC is restricted, the number of supportable VP/VCs is restricted. Accordingly, the capacity of a system is restricted

### SUMMARY OF THE INVENTION

An object of the invention is to solve at least the above problems and/or disadvantages and to provide at least the advantages described hereinafter.

Accordingly, an object of the present invention is to provide an apparatus and method for operating a timing device of a communication system in a way that increases transmission capacity and reduces operating and/or hardware restrictions compared with timing units of conventional communications systems.

Another object of the present invention is to provide a method for controlling a timing apparatus of an asynchronous transfer mode (ATM) system, where the number of timers in the apparatus does not restrict the number of virtual paths/virtual channels (VPs/VCs) that can be handled by the system. The aforementioned object is realized, in at least one way, by removing the need to have a one-to-one correspondence between a plurality of timers and a plurality of virtual paths/virtual channels in the apparatus, and more specifically by replacing the multiple timers used in a conventional timing device with a single timer which records receiving times of packets received from multiple virtual paths/virtual channels. The single timer then cooperates with a control unit to transmit the packets within a certain time period. By using a single timer for multiple VPs/VCs, the present invention advantageously removes the operating and hardware limitations which constrain the performance of conventional timing devices.

To achieve these and other advantages and in accordance with the purposes of the present invention, as embodied and broadly described herein, there is provided an apparatus for operating timer of a communication system, comprising a service logic for receiving data and generating a base address for temporarily storing the data; a data memory for temporarily storing the data by the destination according to the base address; a time counter for outputting a receiving time of the data; a timer input controller for inputting the receiving time and the base address; a timer memory for storing the inputted receiving time and base address; and a timer output controller for periodically detecting the stored receiving time.

The present invention is also an apparatus for operating timer of an ATM system, comprising an ATM adaptation layer (AAL) 2 service logic for receiving an AAL2 packet by each virtual path/virtual channel (VP/VC), outputting a base address of the AAL2 packet to be stored temporarily, and generating a payload of an AAL2 ATM cell using the AAL2 packet; a data memory for temporarily storing the received AAL2 packet by each VP/VC according to the base address; a time counter for outputting a receiving time of the AAL2 packet; a timer input controller for inputting the base address and the receiving time; a timer memory for storing the inputted base address and receiving time by each VP/VC; and a timer output controller for predetermining a restricted time for periodically generating the packet, and detecting the timer memory periodically based on the restricted time.

The present invention is also a method for operating timer of an AAL2 service logic in an ATM system, comprising the steps of outputting a receiving information when an AAL2 packet is received; recording a receiving time of the AAL2 packet by each VP/VC, according to the receiving information; checking the recorded receiving time of the AAL2 packet by each VP/VC; reporting that a restricted time of a VP/VC has lapsed, when there exists the VP/VC of which the restricted time for periodically generating a payload of an AAL2 ATM cell has lapsed; and generating the payload of the AAL2 ATM cell by the AAL2 packet of the reported VP/VC without waiting for the arrival of a next AAL2 packet of the VP/VC according to the report.

The foregoing and other objects, features, aspects and advantages of the present invention will become more apparent from the following detailed description of the present invention when taken in conjunction with the accompanying drawings.

### DESCRIPTION OF THE DRAWINGS

The accompanying drawings, which are included to provide a further understanding of the invention and are incorporated in and constitute part of this specification, illustrate embodiments of the invention and together with the written description serve to explain principles of the invention. In the drawings:

FIG. 1 shows a service protocol layer structure of a common asynchronous transfer mode (ATM) system;

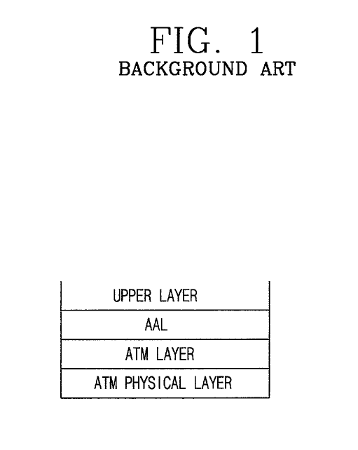

FIG. 2 shows an example of the structure of a timer operating apparatus in a conventional ATM adaptation layer (AAL)2 protocol service logic;

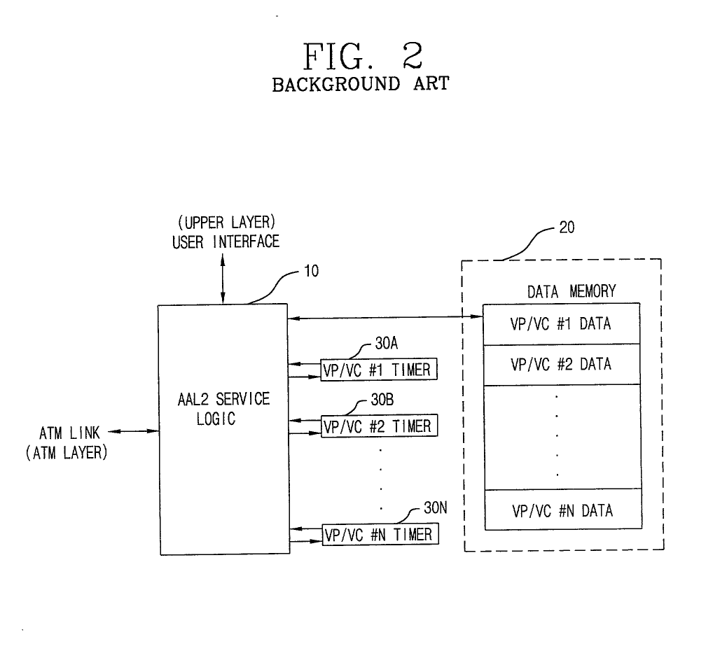

FIG. 3 shows an example of a timer operating apparatus of an AAL2 service logic in an ATM system according to an embodiment of the present invention;

FIG. 4 is a flowchart showing the operation of a timer input controller according to the embodiment of the present invention; and

FIG. 5 is a flowchart showing the operation of a timer output controller according to the embodiment of the present invention.

### DETAILED DESCRIPTION OF PREFERRED EMBODIMENTS

A preferred embodiment of the present invention will now be described with reference to the attached drawings.

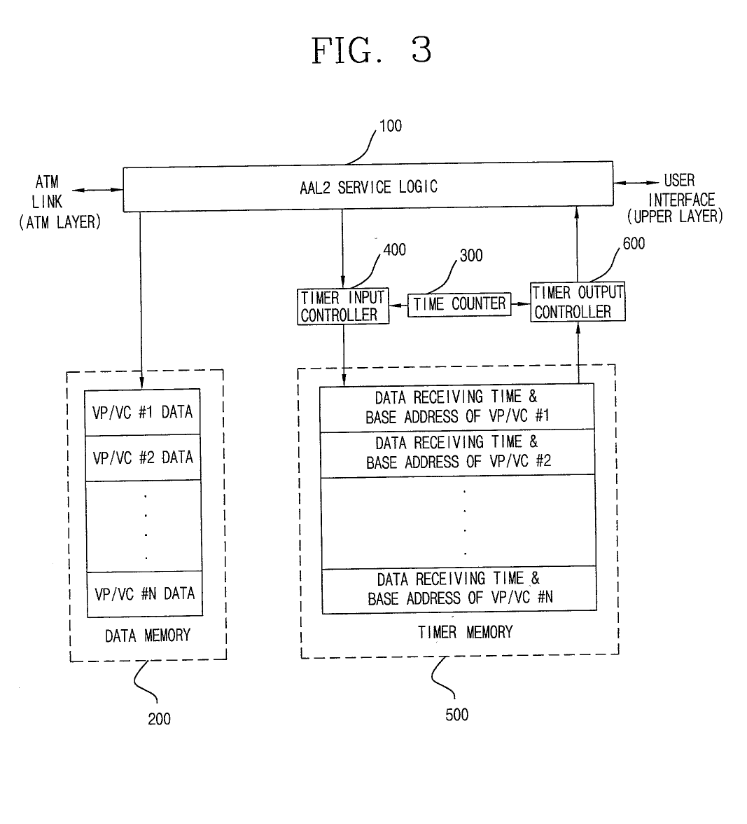

FIG. 3 shown an example of the structure of a timer operating apparatus of an asynchronous transfer mode (ATM) adaptation layer (AAL)2 service logic in an ATM system according to an embodiment of the present invention. As shown, the timer operating apparatus includes an AAL2 service logic 100 for generating a base address for temporarily storing AAL2 data received from an upper layer for each virtual path/virtual channel (VP/VC), and for periodically generating the payload of an AAL2 ATM cell using the stored AAL2 data. A data memory 200 temporarily stores the AAL2 data for each VP/VC according to the control of the AAL2 service logic 100. In addition to these features, the timer operating apparatus includes a time counter 300 for outputting a receiving time of the AAL2 data, and a timer input controller 400 for calculating a corresponding address of a timer memory 500 using the base address when the base address in each VP/VC is generated by the AAL2 service logic 100 and for inputting the base address and the receiving time in the corresponding address for each VP/VC. The timer memory 500 stores the inputted base address and receiving time for each VP/VC. Also included is a timer output controller 600 for periodically and sequentially detecting the timer memory 500, for checking whether restricted time for generating the payload of the AAL2 ATM cell of each VP/VC has lapsed, and for reporting that time is out when the restricted has lapsed.

The operation of the timer operating apparatus of the AAL2 service logic in the ATM system according to the embodiment of present invention, which has the above structure, will now be described.

A case where the AAL2 data is received from the upper layer of the AAL and is transferred to the ATM layer that is the lower layer will now be described. Description of a case where the AAL2 data is received from the ATM layer and is transferred to the upper layer will be omitted.

The timer operating apparatus of the AAL2 service logic according to the embodiment of the present invention includes a time counter 300 for counting time regardless of the number of VP/VCs. The timer input controller 400 manages the time at which an AAL2 common part sublayer (CPS) packet is received by each VP/VC. The timer output controller 600 manages the restricted time.

When the AAL2 CPS packets are received from the upper layer, the AAL2 service logic 100 temporarily stores the received AAL2 CPS packets in the data memory 200 by each VP/VC and outputs an address of the temporarily stored AAL2 CPS packets to the timer input controller 400 as the base address. The AAL2 service logic 100 needs not store the AAL2 CPS packets in the data memory 200 in the order of VP/VC index. The AAL2 service logic 100 can store the AAL2 CPS packets of the VP/VCs in the order that the AAL2 CPS packets are received.

The timer input controller 400 calculates the address of the timer memory 500 using the base address by each VP/VC, which is output from the AAL2 service logic 100, and stores the base address by each VP/VC and the receiving time currently output from the time counter 300 in the calculated address.

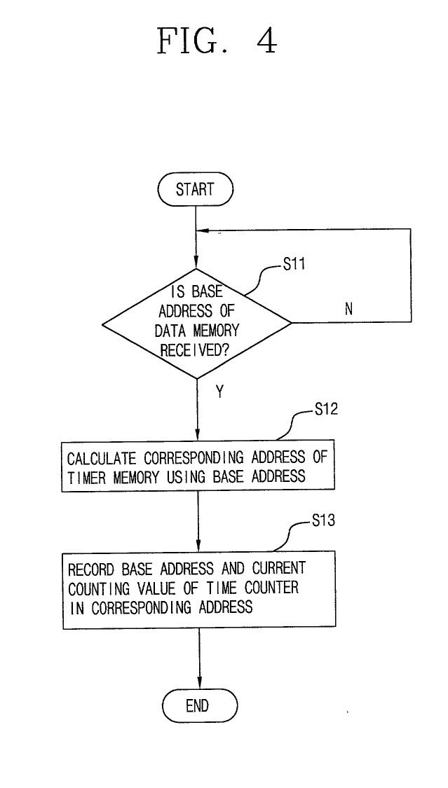

FIG. 4 is a flowchart showing the operation of the timer input controller 400. When the base address of the data memory 200 is output from the AAL2 service logic 100 (S11), the timer input controller 400 calculates the corresponding address of the timer memory 500 using the base address (S12) and determines that the AAL2 CPS packet of the corresponding VP/VC is received. The time counting value output from the time counter 300 is considered the receiving time of the AAL2 CPS packet of the VP/VC. The timer input controller 400 records the base address and the receiving time in the corresponding address of the timer memory 500 (S13).

The timer input controller 400 can obtain the corresponding address of the timer memory 500 by adding a uniform offset value to the base address of the data memory 200. Therefore, the timer input controller 400 can access the corresponding address of the timer memory 500, where the base address and the receiving time of each VP/VC are stored, using only the base address of the data memory 200.

The timer output controller 600 periodically and sequentially detects the timer memory 500. Therefore, it is checked whether the restricted time of each VP/VC has lapsed by comparing the receiving time of each VP/VC, which is stored in the data memory 500, with the current counting value, which is output from the time counter 300. When the restricted time for generating the payload of the AAL2 ATM cell of a specific VP/VC has lapsed, the timer output controller 600 reports the AAL2 service logic 100 that the time of the VP/VC is out and outputs the base address of the VP/VC.

The AAL2 service logic 100, which receives the report that the time of the VP/VC is out, does not wait for a next AAL2 CPS packet of the VP/VC, whose time is out, to be received. Rather, service logic 100 generates an AAL2 CPS protocol data unit (PDU) based only on the AAL2 CPS packet of the corresponding VP/VC which is temporarily stored in the base address received from the timer output controller 600, and then transfers the generated AAL2 CPS PDU to the ATM layer. The above processes will be now described in more detail.

When the AAL2 CPS packet of VP/VC #1 is received from the upper layer, the AAL2 service logic 100 temporarily stores the received AAL2 CPS packet of the VP/VC #1 in the data memory 200 and outputs the base address of the temporarily stored data memory 200 to the timer input controller 400.

The timer input controller 400 accesses an address of the timer memory 500 using the base address of the VP/VC #1, which is received from the AAL2 service logic 100, and records the base address of the VP/VC #1 and the receiving time currently output from the time counter 300.

In a case where the restricted time for the AAL2 service logic 100 generating the AAL2 CPS PDU is 20 ms for a real-time service, when the next AAL2 CPS packet of the VP/VC #1 arrives within 20 ms, the AAL2 service logic 100 generates the AAL2 CPS PDU using the AAL2 CPS packet of the VP/VC #1, which has just arrived and the AAL2 CPS packet of the VP/VC #1 which is temporarily stored in the data memory 200. Service logic 100 then informs the timer input controller 400 that the next AAL2 CPS packet of the VP/VC #1 has arrived.

The timer input controller 400 updates the receiving time of the VP/VC #1, which is stored in the timer memory 500, to the current counting value output from the time counter 300. The timer input controller 400 also records the time, at which the AAL2 CPS packet arrives, in each VP/VC according to the control of the AAL2 service logic 100.

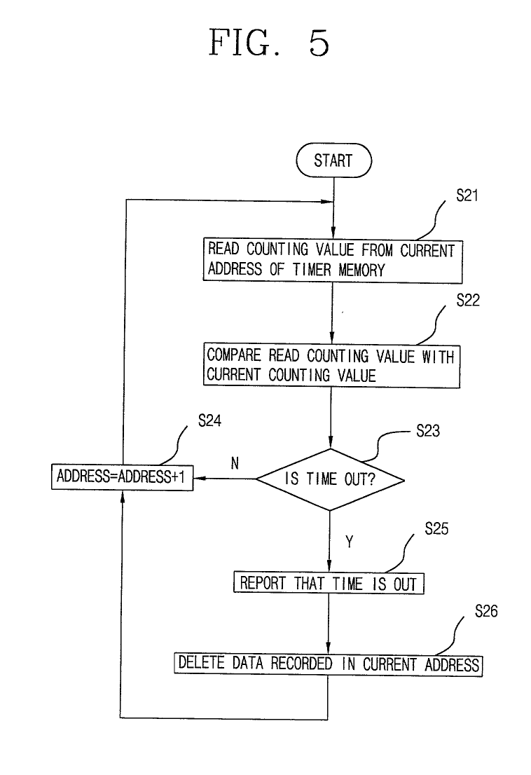

As shown in FIG. 5, the timer output controller 600 periodically and sequentially detects the timer memory 500. More specifically, the timer output controller 600 considers the first address of the timer memory 500 as a current address and reads a receiving time of a corresponding VP/VC from the current address (S21). The timer output controller 600 subtracts the read receiving time from the current output value of the time counter 300 and compares whether the subtracted resulting value is larger than the restricted time(S22). When the subtracted resulting value is not larger than the restricted time, the timer output controller 600 identifies the restricted time has not lapsed, increases the current address to a predetermined degree (S24) and reads a receiving time of a corresponding VP/VC from the increased address (S21).

When the subtracted resulting value is larger than the restricted time, the timer output controller 600 identifies that the restricted time for the corresponding VP/VC has lapsed, fetches a base address of the corresponding VP/VC from the current address, includes the base address in a time-out signal, and outputs the time-out signal to the AAL2 service logic 100 (S25). The timer output controller 600 deletes the base address and the receiving time of the corresponding VP/VC, which are stored in the current address (S26).

The timer output controller 600 manages the restricted time for generating the AAL2 CPS PDU of each VP/VC by the above-mentioned method. The AAL2 service logic 100 does not wait for the arrival of the next AAL2 CPS packet of the corresponding VP/VC, but rather generates the AAL2 CPS PDU by using the AAL2 CPS packet of the corresponding VP/VC of the data memory 200 and by filling the remaining bits with a specific value, for example, 0, according to a report of the timer output controller 600 indicating that the time of the VP/VC is out. The AAL2 service logic 100 transfers the generated AAL2 CPS PDU to the ATM layer through the ATM link.

The apparatus and method for operating a timer apparatus of a communication system according to the present invention is advantageous because it is not restricted in the manner of conventional timing systems. Instead of using a separate timer for each of a plurality of virtual paths/virtual channels, the present invention uses a single timer for all VP/VCs in the system. A timer input controller then manages the packet arrival time (receiving time) for each VP/VC and stores this time in a timer memory. A timer output controller then manages the restricted time for each VP/VC by searching the timer memory for time-outs. If a time-out occurs and an additional data packet has not been received on that VP/VC, the data packet is transmitted to avoid the creation of a data transfer delay. Through these features, the present invention is able to achieve greater transmission capacity in terms of the number of VP/VCs it can handle, because there is no restriction of the number of timers which can be employed. Also, it is possible to improve efficiency of the operation of timers of the system by not restricting the number of timers in the communication system that requires a large number of timers.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. An apparatus for operating a timer of a communication system, comprising:
a service logic for receiving data and generating a base address for temporarily storing the data;
a data memory for temporarily storing the data based on destination according to the base address;
a time counter for outputting a receiving time of the data;
a timer input controller for inputting the receiving time and the base address;
a timer memory for storing the inputted receiving time and base address; and
a timer output controller for periodically detecting the stored receiving time.

2. The apparatus of claim 1, wherein the timer output controller predetermines a restricted time for periodically generating the packet, compares the receiving time and a current time outputted from the time counter, outputs a time out signal to the service logic when the restricted time has lapsed, and deletes the receiving time and the base address of the corresponding destination from the timer memory.

3. The apparatus of claim 2, wherein the service logic fetches the data using the base address included in the time out signal and generates the packet.

4. An apparatus for operating a timer of a communication system, comprising:
a service logic which generates abase address for temporarily storing a received data and a packet based on the temporarily stored data by destination;
a time counter which outputs a receiving time of the data;
a timer input controller which inputs the receiving time and the base address; and
a timer output controller which predetermines a restricted time for periodically generating the packet, and which periodically detects the inputted receiving time based on the restricted time.

5. The apparatus of claim 4, further comprises:
a data memory which temporarily stores the data by destination according to the base address; and
a timer memory which stores the inputted receiving time and base address;

6. The apparatus of claim 4, wherein the timer output controller subtracts the inputted receiving time from a current time outputted by the time counter, and outputs a time out signal for generating the packet to the service logic, when the subtracted resulting value is larger than the restricted time.

7. An apparatus for operating a timer of an asynchronous transfer mode (ATM) system, comprising:
an ATM adaptation layer (AAL)2 service logic for receiving an AAL2 packet from a virtual path/virtual channel (VP/VC), outputting a base address of the AAL2 packet to be stored temporarily, and generating a payload of an AAL2 ATM cell using the AAL2 packet;
a data memory for temporarily storing the received AAL2 packet based on VP/VC according to the base address;
a time counter for outputting a receiving time of the AAL2 packet;
a timer input controller for inputting the base address and the receiving time;
a timer memory for storing the inputted base address and receiving time based on VP/VC; and
a timer output controller for predetermining a restricted time for periodically generating the packet, and detecting the timer memory periodically based on the restricted time.

8. The apparatus of claim 7, wherein the AAL2 service logic obtains the base address from a time out signal, fetches the AAL2 packet using the obtained base address, and generates the payload of the ATM cell using the AAL2 packet, when the timer output controller outputs the time out signal.

9. The apparatus of claim 7, wherein the timer out controller compares the receiving time and a current time outputted from the time counter, outputs a time out signal to the AAL2 service logic when the restricted time has lapsed, and deletes the receiving time and the base address of the corresponding destination from the timer memory.

10. A method for operating a timer of an AAL2 service logic in an ATM system, comprising:
(a) outputting a receiving information when an AAL2 packet corresponding to a specific VP/VC is received;
(b) recording a receiving time of the AAL2 packet based on VP/VC, the recorded receiving time derived from the receiving information;
(c) checking the recorded receiving time of the AAL2 packet;
(d) reporting that a restricted time has lapsed for transmitting an AAL2 ATM cell on said specific VP/VC; and
(e) generating a payload of the AAL2 ATM cell based on the AAL2 packet without waiting for arrival of a next AAL2 packet on said specific VP/VC.

11. The method of claim 10, wherein the step (b) comprises:
(b1) calculating a corresponding address of a timer memory using a base address of a data memory, which stores data of the AAL2 packet; and
(b2) recording the base address and the receiving time of the AAL2 packet in the calculated address of the timer memory.

12. The method of claim 11, wherein, in the step (b1), the data memory temporarily stores the received AAL2 packet based on VP/VC, and the timer memory stores the base address and receiving time of the temporarily stored AAL2 packet,
and wherein the corresponding address of the timer memory is obtained by adding an offset value to the base address of the data memory.

13. The method of claim 10, further comprising the steps of, when a next AAL2 packet of said specific VP/VC is received before the restricted time has lapsed, informing that the next AAL2 packet is received and generating the payload of the AAL2 ATM cell using the previously received AAL2 packet of said specific VP/VC and the next AAL2 packet, at the same time.

14. A system for managing data communications, comprising:
a first memory area;
a second memory area;
a timer which records a time when a data packet is received; and
a control unit which stores data from the data packet in a base address of the first memory area, and which stores information indicative of the base address and the receiving time recorded by the timer in the second memory area, said control unit controlling transmission of the data from the data packet stored in the first memory area based on said receiving time information stored in the second memory area.

15. The system of claim 14, wherein the control unit includes:
a timer output controller which periodically detects said receiving time information stored in the second memory area, compares a current time to the receiving time information, and determines whether a difference between the current time and said receiving time information equals a predetermined time-out period.

16. The system of claim 15, wherein if the timer output controller determines that another data packet has not been received when said difference equals the predetermined time-out period, the control unit generates a data unit for transmission whose data portion is only derived from the data packet.

17. The system of claim 16, wherein if another data packet is received before the timer output controller determines that said difference equals the predetermined time-out period, the control unit generates a data unit for transmission whose data portion is derived from the data packet and said another data packet.

18. The system of claim 14, wherein the control unit stores said information indicative of the base address and the receiving time at an address location in the second memory area which is based on the base address in the first memory area.

19. The system of claim 14, wherein the data packet is an AAL2 packet.

20. A system for managing data communications, comprising:
a timer which records receiving times of data packets associated with different virtual paths/virtual channels; and
a control unit which stores data from the data packets in different base addresses of a first memory area, and which stores information indicative of the base address and the receiving time of the data from each of said data packets in a second memory area, said control unit controlling transmission of the data from the data packets stored in the first memory area based on said receiving time information stored in the second memory area.

21. The system of claim 20, wherein the control unit includes:
a timer output controller which periodically detects said receiving time information stored in the second memory area, compares a current time to the receiving time information, and determines whether a difference between the current time and said receiving time information equals a predetermined time-out period.

22. The system of claim 21, wherein, for each of said virtual paths/channel paths, if the timer output controller determines that another data packet has not been received for that virtual path/virtual channel when said difference equals the predetermined time-out period, the control unit generates a data unit for transmission whose data portion is only derived from the data packet stored in the first memory area for that virtual path/virtual channel.

23. The system of claim 22, wherein, for each of said virtual paths/channel paths, if another data packet is received for that virtual path/virtual channel before the timer output controller determines that said difference equals the predetermined time-out period, the control unit generates a data unit for transmission whose data portion is derived from the data packet stored in the first memory area for that virtual path/virtual channel and said another data packet.

24. The system of claim 20, wherein the control unit stores said base address and receiving time information at address locations in the second memory area which are respectively based on the base addresses stored in the first memory area.

25. The system of claim 20, wherein the data packets are AAL2 packets.

26. A method for managing data communications, comprising:
recording a time when a data packet is received;
storing data from the data packet in a base address of a first memory area;
storing information indicative of the base address and the receiving time recorded by the timer in a second memory area; and
controlling transmission of the data from the data packet stored in the first memory area based on said receiving time information stored in the second memory area.

27. The method of claim 26, wherein said controlling step includes:
periodically detecting said receiving time information stored in the second memory area;
comparing a current time to the receiving time information; and
determining whether a difference between the current time and said receiving time information equals a predetermined time-out period.

28. The method of claim 27, further comprising:
if the timer output controller determines that another data packet has not been received when said difference equals the predetermined time-out period, generating a data unit for transmission whose data portion is only derived from the data packet.

29. The method of claim 28, further comprising:
if another data packet is received before the timer output controller determines that said difference equals the predetermined time-out period, generating a data unit for transmission whose data portion is derived from the data packet and said another data packet.

30. The method of claim 26, further comprising:
storing said information indicative of the base address and the receiving time at an address location in the second memory area which is based on the base address in the first memory area.

31. The method of claim 26, wherein the data packet is an AAL2 packet.

32. A method for managing data communications, comprising:
recording receiving times of data packets associated with different virtual paths/virtual channels;
storing data from the data packets in different base addresses of a first memory area;
storing information indicative of the base address and the receiving time of the data from each of said data packets in a second memory area; and
controlling transmission of the data from the data packets stored in the first memory area based on said receiving time information stored in the second memory area.

33. The method of claim 32, wherein said controlling step includes:
periodically detecting said receiving time information stored in the second memory area;
comparing a current time to the receiving time information; and
determining whether a difference between the current time and said receiving time information equals a predetermined time-out period.

34. The method of claim 33, wherein, for each of said virtual paths/channel paths, if the timer output controller determines that another data packet has not been received for that virtual path/virtual channel when said difference equals the predetermined time-out period, generating a data unit for transmission whose data portion is only derived from the data packet stored in the first memory area for that virtual path/virtual channel.

35. The method of claim 34, wherein, for each of said virtual paths/channel paths, if another data packet is received for that virtual path/virtual channel before the timer output controller determines that said difference equals the predetermined time-out period, generating a data unit for transmission whose data portion is derived from the data packet stored in the first memory area for that virtual path/virtual channel and said another data packet.

36. The method of claim 32, further comprising:
storing said base address and receiving time information at address locations in the second memory area which are respectively based on the base addresses stored in the first memory area.

37. The method of claim 32, wherein the data packets are AAL2 packets.
